(19) United States
(12) Patent Application Publication
(10) Pub. No.: US 2021/0032131 A1
(43) Pub. Date: Feb. 4, 2021

(54) LIQUID TREATMENT APPARATUS AND METHOD

(71) Applicant: CLEAR WAVE LTD., Herzliya (IL)

(72) Inventors: Nahum PARKANSKY, Kfar Saba (IL); Reuven BOXMAN, Herzliya (IL); Ariel MEIROVICH, Jerusalem (IL)

(21) Appl. No.: 16/975,402

(22) PCT Filed: Feb. 28, 2019
(86) PCT No.: PCT/IL2019/050231

§ 371 Date: Aug. 25, 2020

Related U.S. Application Data
(60) Provisional application No. 62/636,848, filed on Mar. 1, 2018.

(51) Int. Cl. C02F 1/46; C02F 1/76; C02F 1/72; C02F 101/30; C02F 103/34

(52) U.S. Cl. CPC C02F 1/4608; C02F 1/76; C02F 2103/343; C02F 2101/308; C02F 1/722

(57) ABSTRACT

A liquid treatment apparatus constituted of: a vessel arranged to contain liquid; at least one first electrode in contact with the liquid; at least one second electrode in contact with the liquid; an electrical pulse generator, a first polarity output of the electrical pulse generator coupled to each of the first electrodes and a second polarity output of the electrical pulse generator coupled to each of the second electrodes, the first polarity opposing the second polarity; at least one third electrode disposed in the liquid in the vessel, and a mechanical force generator arranged to provide a predetermined mechanical force along a predetermined path within the liquid, a portion of the mechanical force applied to the least one third electrode so as to chaotically interrupt a conducting pathway formed by the at least one third electrode between a pair of the first and second electrodes.

### CROSS REFERENCE TO RELATED APPLICATIONS

This application claims the benefit of U.S. Provisional Patent Application Ser. 62/636,848 filed Mar. 1, 2018 entitled “Multi-electrode Reactor for Submerged Pulse Arc Removal of Contaminants from Liquids”.

### TECHNICAL FIELD

The present invention relates to the decontamination of liquids such as water and, more particularly, to decontamination by pulsed submerged arcs.

### BACKGROUND

Organic molecules of diverse sorts may contaminate water, and technology is sought for their removal. One example of a class of contaminants is dyes used in the textile, leather, food processing, cosmetics, paper, and dye manufacturing industries. Many dyes, and their breakdown products, are toxic and it is desirable to remove contaminants from effluent water in manufacturing facilities before the water is discharged into the environment. Due to the aromatic rings present in the dye molecules, conventional biological treatment does not effectively eliminate these molecules. Other contaminants are introduced into water in the process of manufacturing chemicals, pharmaceuticals, and petroleum products. Often these contaminants are toxic to microbes used in prior art biological water treatments.

Plasma technologies can treat contaminated water by several mechanisms including radical reactions, shock waves, ultra-violet radiation, ionic reactions, electron processes and thermal dissociation. It is theorized that these mechanisms, singularly or synergistically, may be responsible for concurrently oxidizing trace contaminates and disinfecting the water.

The submerged arc (SA) discharge is an effective method for removing biologically active molecules from liquids such as water. The SA is a high current electrical discharge between two electrodes submerged in a liquid such as water. The arc produces plasma, which in turn generates ultra-violet radiation and very active oxidant species, such as (in the case of liquid water) OH radicals, which can destroy organic molecules. A detailed description of a prior-art SA discharge method is found in the journal article: “Treatment of Methylene Blue Water Solution by Submerged Pulse Arc in Multi-electrode Reactor,” by A. Meirovich, N. Parkansky, R. L. Boxman, O. Berkh, Z. Barkay, and Yu.i Rosenberg, in the Journal of Water Process Engineering, 10.1016/j.jwpe.2016.08.002, 11 Aug. 2016, pp. 53-60, hereinafter referred to as “REF1”, the entire contents of which is incorporated herein by reference.

In REF1, a submerged pulsed high-current and high voltage electrical discharge between two electrodes in a liquid, sometimes referred to as an electro-hydraulic discharge, has been shown to oxidize many organic compounds such as methyl-tert-butyl ether (MTBE), atrazine, phenol and chlorobenzene. The electrodes were constructed from: carbon, because carbon is generally biocompatible; and iron, because of the possibility of producing Fenton's reagent (H₂O₂, Fe²⁺), which very effectively oxidizes organic compounds, and because any iron micro- or nano-particles which are inevitably produced can be removed magnetically.

A reactor described in REF1 comprises a stainless steel cylinder on a flat dielectric surface (the bottom of the reactor) wherein fixed electrodes are placed. The fixed electrodes are connected to a power supply. Multiple mobile electrodes are placed at the bottom of the reactor and the reactor is vibrated vertically. Each one of the mobile electrodes periodically contacts other mobile electrodes and the fixed electrodes randomly forming a conducting path, and then quickly disengages. Current starts to flow when (or slightly before) the conducting path is formed, and the current continues flowing through an arc plasma which is created when the contact is broken.

What is desired, and not provided by the prior art, is a more efficient method and apparatus for submerged arc treatment of polluted water, which cost-effectively provide submerged arcs dispersed in a large volume of liquid.

### SUMMARY

Accordingly, it is a principal object to overcome at least some of the disadvantages of the prior art. This is provided in certain embodiments by an apparatus for treating a liquid, the apparatus comprising: a vessel arranged to contain the liquid; at least one first electrode in contact with the liquid in the vessel; at least one second electrode in contact with the liquid in the vessel; an electrical pulse generator, a first polarity output of the electrical pulse generator coupled to each of the first electrodes and a second polarity output of the electrical pulse generator coupled to each of the second electrodes, the first polarity opposing the second polarity; at least one third electrode disposed in the liquid in the vessel, and a mechanical force generator arranged to provide a predetermined mechanical force along a predetermined path within the liquid, a portion of the predetermined mechanical force applied to the least one third electrode so as to chaotically interrupt a conducting pathway formed by the at least one third electrode between a pair of the first and the second electrodes.

In one embodiment, the portion of the predetermined mechanical force is applied to the at least one third electrode so as to further cause the formation of the conducting pathway. In another embodiment, the mechanical force generator comprises a motor coupled to rotate the first and second electrodes about a central axis, wherein the first and second electrodes form a rotation assembly, and wherein each of the first electrodes is adjacent to a respective one of the second electrodes, the portion of the provided predetermined rotational mechanical force provided to the at least one third electrode by contact with the rotation assembly. In one further embodiment, the third electrode has at least one dimension greater than a distance between the adjacent first and second electrodes.

In one embodiment, the mechanical force generator comprises a motor coupled to rotate the first and second electrodes about a central axis, wherein the first and second electrodes form a plurality of concentric rotation assemblies, wherein each of the first electrodes is adjacent to a respective one of the second electrodes of the respective rotation assembly, the portion of the provided predetermined rotational mechanical force provided to the at least one third electrode by contact with a respective one of the concentric rotation assemblies. In one further embodiment, the third electrode has at least one initial dimension greater than a distance between the adjacent first and second electrodes of an inner one of the plurality of concentric rotation assemblies. In one yet further embodiment, a distance between the adjacent first and second electrodes of an outer one of the plurality of concentric rotation assemblies is less than a distance between the adjacent first and second electrodes of an inner one of the plurality of concentric rotation assemblies.

In another embodiment: the mechanical force generator comprises a pump in communication with the liquid so as to provide predetermined pumped flow; the first and second electrodes are fixed in relation to the vessel; and the third electrodes are submerged in the liquid. In one further embodiment, the vessel is dimensioned in cooperation with the pump such that an average liquid velocity over a portion of the vessel is equal to a free falling velocity of the third electrodes.

In another further embodiment, the vessel is dimensioned in cooperation with the pump such that: an average liquid velocity in a first portion of the vessel is greater than a free falling velocity of the third electrodes; an average liquid velocity in a second portion of the vessel is equal to the free falling velocity of the third electrodes; and an average liquid velocity in a third portion of the vessel is less than the free falling velocity of the third electrodes. In one yet further embodiment the second portion of the vessel is above the first portion of aid vessel and below the third portion of the vessel.

In one further embodiment, the apparatus further comprises fixed magnets arranged vertically about a wall of the vessel, and about a center thereof, and wherein the third electrodes are responsive to a magnetic field formed by the fixed magnets to form the conducting pathway, the pump arranged to generate the pumped flow orthogonal to the magnetic field. In another further embodiment, the vessel is generally cylindrical shaped, the first electrode comprising an inner wall of the vessel and the second electrode comprises a grate arranged to allow passage of the fluid while reflecting the at least one third electrodes.

In one embodiment, the third electrodes are generally neutrally buoyant, so as to remain suspended in the liquid. In one further embodiment, the third electrodes comprise a magnetic material coupled to a buoyant material. In another further embodiment, a plurality of the third electrodes are coupled to a single buoyant material.

In one embodiment, the apparatus further comprises: a first predetermined amount of H₂O₂; and a second predetermined amount of HCl, wherein the first predetermined amount of H₂O₂ and the second predetermined amount of HCl is added to the liquid.

In one independent embodiment, an apparatus for treating a liquid is provided, the apparatus comprising: a vessel arranged to contain the liquid; at least one first electrode in contact with the liquid in the vessel; at least one second electrode in contact with the liquid in the vessel; an electrical pulse generator, a first polarity output of the electrical pulse generator coupled to each of the first electrodes and a second polarity output of the electrical pulse generator coupled to each of the second electrodes, the first polarity opposing the second polarity; at least one third electrode disposed in the liquid in the vessel, and a mechanical force generator arranged to provide a predetermined mechanical force along a predetermined path within the liquid, a portion of the predetermined mechanical force applied to the least one third electrode so as to chaotically interrupt a conducting pathway formed by the at least one third electrode between a pair of the first and the second electrodes.

In one embodiment, the portion of the predetermined mechanical force is applied to the at least one third electrode so as to further cause the formation of the conducting pathway. In another embodiment, the mechanical force generator comprises a motor coupled to rotate the first and second electrodes about a central axis, wherein the first and second electrodes form a rotation assembly and each of the first electrodes is adjacent to a respective one of the second electrodes, the portion of the provided predetermined mechanical force provided to the at least one third electrode by contact with the rotation assembly. In one further embodiment, the third electrode has at least one dimension greater than a distance between the adjacent first and second electrodes.

In one embodiment, the mechanical force generator comprises a motor coupled to rotate the first and second electrodes about a central axis, wherein the first and second electrodes form a plurality of concentric rotation assemblies, wherein each of the first electrodes is adjacent to a respective one of the second electrodes of the respective rotation assembly, the portion of the provided predetermined mechanical force provided to the at least one third electrode by contact with a respective one of the concentric rotating assemblies. In one further embodiment, the third electrode has at least one initial dimension greater than a distance between the adjacent first and second electrodes of an inner one of the plurality of concentric rotation assemblies. In another further embodiment, a distance between the adjacent first and second electrodes of an outer one of the plurality of concentric rotation assemblies is less than a distance between the adjacent first and second electrodes of an inner one of the plurality of concentric rotation assemblies.

In one embodiment: the mechanical force generator comprises a pump in communication with the liquid; the first and second electrodes are fixed in relation to the vessel; and the third electrodes are submerged in the liquid. In one further embodiment, the vessel is dimensioned in cooperation with the pump such that an average liquid velocity over a portion of the vessel is equal to a free falling velocity of the third electrodes.

In another further embodiment, the vessel is dimensioned in cooperation with the pump such that: an average liquid velocity in a first portion of the vessel is greater than a free falling velocity of the third electrodes; an average liquid velocity in a second portion of the vessel is equal to the free falling velocity of the third electrodes; and an average liquid velocity in a third portion of the vessel is less than the free falling velocity of the third electrodes. In one yet further embodiment, the second portion of the vessel is above the first portion of aid vessel and below the third portion of the vessel.

In one further embodiment, the apparatus further comprises fixed magnets arranged vertically about a wall of the vessel, and about a center thereof, and wherein the third electrodes are responsive to a magnetic field formed by the fixed magnets to form the conducting pathway, the pump arranged such that the predetermined path of the predetermined mechanical force is orthogonal to the magnetic field. In another further embodiment, the vessel is generally cylindrical shaped, the first electrode comprising an inner wall of the vessel and the second electrode comprises a grate arranged to allow passage of the fluid while reflecting the at least one third electrode.

In one embodiment, the third electrodes are generally neutrally buoyant, so as to remain suspended in the liquid. In one further embodiment, the third electrodes comprise a magnetic material coupled to a buoyant material. In another further embodiment, a plurality of the third electrodes are coupled to a single buoyant material.

In one embodiment, the apparatus further comprises: a first predetermined amount of H₂O₂; and a second predetermined amount of HCl, wherein the first predetermined amount of H₂O₂ and the second predetermined amount of HCl is added to the liquid.

In another independent embodiment, a liquid treatment method is provided, the method comprising: providing electric pulses to at least one first electrode in contact with a liquid inside a vessel and to at least one second electrode in contact with the liquid, a first polarity of the provided electric pulses provided to the at least one first electrode and a second polarity of the provided electric pulses provided to the at least one second electrode, the first polarity opposing the second polarity; and providing a predetermined mechanical force along a predetermined path within the liquid, a portion of the predetermined mechanical force applied to the least one third electrode so as to chaotically interrupt a conducting pathway formed by the at least one third electrode between a pair of the first and the second electrodes.

In one embodiment, the portion of the provided predetermined mechanical force is applied to the at least one third electrode so as to further cause the formation of the conducting pathway. In another embodiment, the providing the predetermined mechanical force along the predetermined path comprises rotating the first and second electrodes about a central axis, the first and second electrodes forming a rotation assembly, wherein each of the first electrodes is adjacent to a respective one of the second electrodes, wherein the portion of the provided predetermined mechanical force is provided to the at least one third electrode by contact with the rotation assembly. In one further embodiment, the third electrode has at least one dimension greater than a distance between the adjacent first and second electrodes.

In one embodiment, the providing the predetermined mechanical force along the predetermined path comprises rotating the first and second electrodes about a central axis, the first and second electrodes forming a plurality of concentric rotation assemblies, wherein each of the first electrodes is adjacent to a respective one of the second electrodes of the respective rotation assembly, and wherein the portion of the provided predetermined mechanical force is provided to the at least one third electrode by contact with a respective one of the concentric rotation assemblies. In one further embodiment, the third electrode has at least one initial dimension greater than a distance between the adjacent first and second electrodes of an inner one of the plurality of concentric rotation assemblies. In one yet further embodiment, a distance between the adjacent first and second electrodes of an outer one of the plurality of concentric rotation assemblies is less than a distance between the adjacent first and second electrodes of an inner one of the plurality of concentric rotation assemblies.

In one embodiment: the providing the predetermined mechanical force along the predetermined path comprises pumping the liquid through the vessel; the first and second electrodes are fixed in relation to the vessel; and the third electrodes are submerged in the liquid. In one further embodiment, the vessel is dimensioned in cooperation with the pumping such that an average liquid velocity over a portion of the vessel is equal to a free falling velocity of the third electrodes.

In another further embodiment, the vessel is dimensioned in cooperation with the pumping such that: an average liquid velocity in a first portion of the vessel is greater than a free falling velocity of the third electrodes; an average liquid velocity in a second portion of the vessel is equal to the free falling velocity of the third electrodes; and an average liquid velocity in a third portion of the vessel is less than the free falling velocity of the third electrodes. In one yet further embodiment, the second portion of the vessel is above the first portion of aid vessel and below the third portion of the vessel.

In one further embodiment, the method further comprises providing a fixed magnetic field, the third electrodes responsive to the provided fixed magnetic field to form the conducting pathway, the pumping is arranged such that the predetermined path of the provided predetermined mechanical force is orthogonal to the provided fixed magnetic field. In another further embodiment, the vessel is generally cylindrical shaped, the first electrode comprising an inner wall of the vessel and the second electrode comprises a grate arranged to allow passage of the fluid while reflecting the at least one third electrode.

In one embodiment, the third electrodes are generally neutrally buoyant, so as to remain suspended in the liquid. In one further embodiment, the third electrodes comprise a magnetic material coupled to a buoyant material. In another further embodiment, a plurality of the third electrodes are coupled to a single buoyant material.

In another embodiment, the method further comprises: adding a first predetermined amount of H₂O₂ to the liquid; and adding a second predetermined amount of HCl to the liquid.

Additional features and advantages of the invention will become apparent from the following drawings and description.

### BRIEF DESCRIPTION OF THE DRAWINGS

For a better understanding of certain embodiments and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments only, and are presented in the cause of providing what is believed to be the most useful and readily understood description of the principles and conceptual aspects. In this regard, no attempt is made to show structural details in more detail than is necessary for a fundamental understanding, the description taken with the drawings making apparent to those skilled in the art how the several forms may be embodied in practice. In the accompanying drawings:

FIG. 1 illustrates a high level schematic diagram of a first embodiment of a liquid treatment apparatus;

FIG. 2 illustrates a high level schematic diagram of a second embodiment of a liquid treatment apparatus;

FIGS. 3A-3B illustrate various high level schematic cross-sectional diagrams of a third embodiment of a liquid treatment apparatus;

FIG. 4 illustrates a high level schematic cross-section diagram of a buoyant electrode assembly, in accordance with certain embodiments;

FIG. 5 illustrates a high level schematic diagram of a fourth embodiment of a liquid treatment apparatus;

FIG. 6 illustrates a high level schematic diagram of a fifth embodiment of a liquid treatment apparatus;

FIG. 7 illustrates a high level schematic diagram of a sixth embodiment of a liquid treatment apparatus;

FIG. 8 illustrates a high level schematic diagram of a chemical substance addition system, in accordance with certain embodiments;

FIG. 9 illustrates a graph of results of a first set of experiments of liquid treatment, in accordance with certain embodiments;

FIG. 10 illustrates a graph of results of a second set of experiments of liquid treatment, in accordance with certain embodiments; and

FIG. 11 illustrates a high level flow chart of a liquid treatment method, in accordance with certain embodiments.

### DETAILED DESCRIPTION

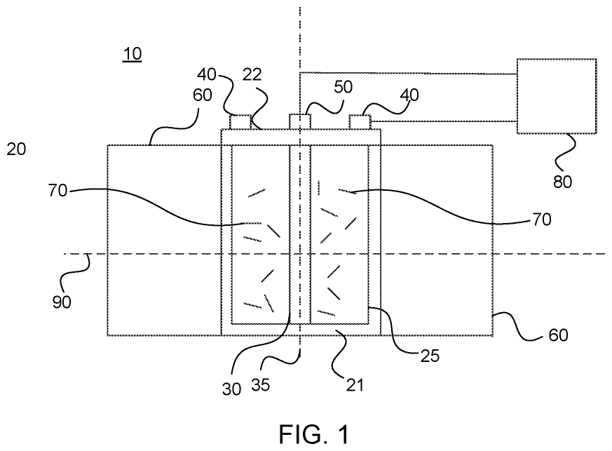

FIG. 1 illustrates a high level schematic diagram of a liquid treatment apparatus 10. Liquid treatment apparatus 10 shows the inventors' work which was presented on a poster at the international conference on plasmas with liquids in Prague, Czech Republic, from Mar. 6-8, 2017, the poster titled “Multi-Electrode Pulsed Submerged Arc Water Treatment”.

Liquid treatment apparatus 10 comprises: a vessel 20 extending from a first end 21 to a second end 22 and arranged to contain liquid, walls 25 of vessel 20 arranged to form a first electrode; a second electrode 30 exhibiting a longitudinal axis 35; a first terminal 40; a second terminal 50; a 3-phase coil set 60; a plurality of third electrodes 70 disposed within the liquid in vessel 20; and an electric pulse generator 80. Second electrode 30 extends from first end 21 to second end 22 of vessel 20. In one embodiment, vessel 20 is generally cylindrical shaped. In another embodiment, second electrode 30 is positioned in the center of vessel 20. In one non-limiting embodiment, third electrodes 70 comprise wires and/or nails.

First terminal 40 is in electrical communication with first electrode 25 and second terminal 50 is in electrical communication with second electrode 30. First terminal 40 is further in electrical communication with a first polarity output of electric pulse generator 80 and second terminal 50 is in electrical communication with a second polarity output of electric pulse generator 80, the second polarity opposing the first polarity. 3-phase coil set 60 surrounds vessel 20 and is in electrical communication with a power source, either a dedicated power source or electric pulse generator 80.

In operation, each coil of 3-phase coil set 60 generates a respective magnetic field in a respective direction in a plane 90, plane 90 generally perpendicular to longitudinal axis 35 of second electrode 30. Due to the 3-phase setup, the direction of the magnetic field generated by 3-phase coil set 60 rotates at the excitation frequency of the coils. Looking at plane 90 as the x-y plane, at a first stage the magnetic field extends in the x-direction, at a second stage the magnetic field extends in the y-direction, at a third stage the magnetic field extends in the −x direction, and at a fourth stage the magnetic field extends in the −y direction. At the next stage, the magnetic field extends again in the x-direction, as in the first stage and continuously cycles through the four directions. As a result of the generated rotating magnetic field, third electrodes 70 are levitated. Additionally, third electrodes 70 are aligned in the direction of the magnetic field. Furthermore, the assemblage of third electrodes 70 is rotated about longitudinal axis 35 of second electrode 30. The motion of third electrodes 70 includes a chaotic component.

Occasionally, third electrodes 70 become aligned momentarily such that a continuous conductive path is formed by some of third electrodes 70 between first electrode 25 and second electrode 30, i.e. a current path is formed from first electrode 25 to second electrode 30 via a set of third electrodes 70. When such a continuous path is formed, current flows from the electric pulse generator through this path. Due to the chaotic component of the motion of third electrodes 70, the continuous current path is maintained only momentarily, and when the path is interrupted, an arc discharge is generated across the break in the path, the discharge continuing for an amount of time determined by the electrical characteristics of electric pulse generator 80 and the conducting path. Particularly, electric pulse generator 80 generates predetermined electrical pulses, thereby causing the creation of a pulsed arc discharge between first electrode 25, second electrode 30 and third electrodes 70, the pulsed arc discharge creating plasma bubbles.

This process repeats itself, and the average pulse repetition frequency is determined by the rate at which conducting paths randomly form inside vessel 20. The plasma bubbles formed by the arc discharges kill bacteria and other microbes in the liquid by one or more mechanisms, including: ultra-violet (UV) light generation which can destroy DNA; generation of radical oxidants such as OH., which oxidize molecules in the liquid, including those on the surface of microbes; acoustical waves, including shock waves, which can ablate the microbes; and possibly other mechanisms including electron and ion reactions, and heat. The discharge also forms micro-particles and nano-particles composed of atoms from the electrodes and the liquid. These particles serve as catalysts for the generation of additional radical oxidants, or as photo-catalysts in the presence of UV radiation from the plasma.

The above has been described in relation to a rotating magnetic field generated by a 3-phase coil set, however this is not meant to be limiting in any way and any magnetic field generator which generates a rotating magnetic field can be used without exceeding the scope.

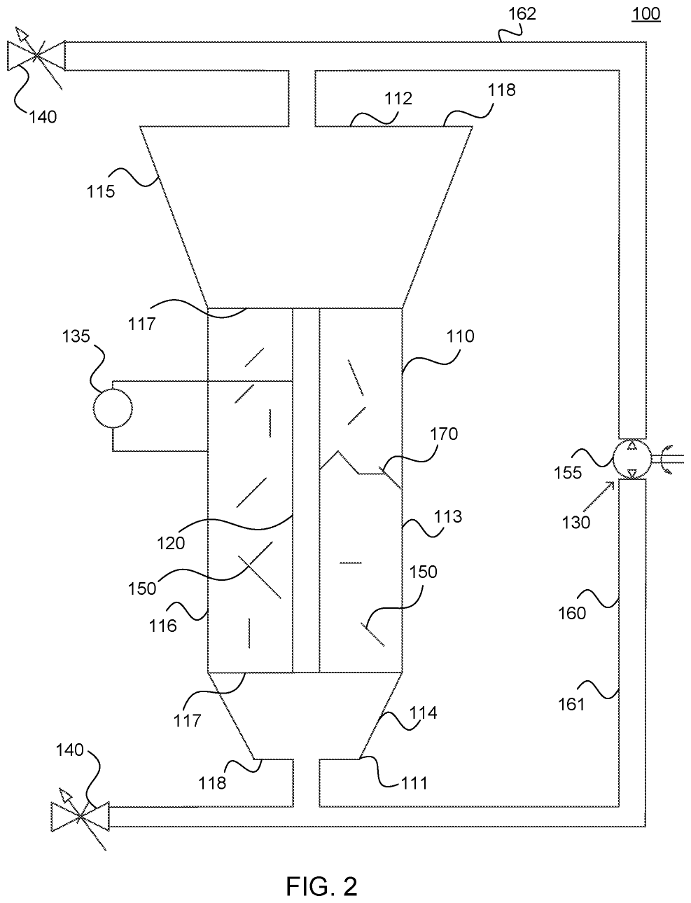

FIG. 2 illustrates a high level schematic diagram of a liquid treatment apparatus 100. Liquid treatment apparatus 100 comprises: a vessel 110 extending from a first end 111 to a second end 112 and arranged to contain liquid, walls 113 of vessel 110 arranged to form a first electrode; a second electrode 120; a mechanical force generator 130; an electric pulse generator 135; an optional pair of valves 140; and a plurality of third electrodes 150 submerged within the liquid in vessel 110. Vessel 110 exhibits: a first section 114 at first end 111 thereof; a second section 115 at second end 112 thereof; and a middle section 116 sandwiched between first section 114 and second section 115. Mechanical force generator 130 comprises: a pump 155; and a pipe 160 exhibiting a first section 161 and a second section 162. In one embodiment, second electrode 120 extends from first end 111 to second end 112 of vessel 110 in the center of vessel 110. In one embodiment, each third electrode 150 exhibits an elongated shape.

In one embodiment, first section 114 and second section 115 of vessel 110 are each generally shaped as a truncated cone exhibiting a first base 117 and a second base 118 opposing first base 117. First base 117 of each of first section 114 and second section 115 faces middle section 116. Second face 118 of each of first section 114 and second section 115 faces pipe 160. In another further embodiment, the diameter of first base 117 of first section 114 is longer than the diameter of second base 118 thereof and the diameter of first base 117 of second section 115 is shorter than the diameter of second base 118 thereof. In one further embodiment, the length of the diameter of first base 117 of first section 114 is generally equal to the length of the diameter of first base 117 of second section 115 and the length of the diameter of second base 118 of first section 114 is shorter than the length of the diameter second base 118 of second section 115. In another embodiment, middle section 116 of vessel 110 is generally cylindrical shaped.

First section 161 of pipe 160 enters first end 111 of vessel 110 and second section 162 of pipe 160 enters second end 112 of vessel 110. In one illustrated embodiment, pump 155 is positioned between first section 161 and second section 162 of pipe 160, however this is not meant to be limiting in any way. In another embodiment, pump 155 is situated within pipe 160. A first of optional valves 140 is connected to first section 161 of pipe 160 and the second of optional valves 140 is connected to second section 162 of pipe 160.

A first polarity output of electric pulse generator 135 is in electrical communication with first electrode 113 and a second polarity output of electric pulse generator 135 is in electrical communication with second electrode 120.

Vessel 110 is positioned such that first end 111 is lower than second end 112 and gravity pulls third electrodes 150 towards first end 111. In operation, mechanical force generator 130 provides a predetermined mechanical force along a predetermined path within the liquid and a portion of the predetermined mechanical force is applied to third electrodes 150. The term “mechanical force”, as used herein, means a force, or momentum, which transfers energy to third electrodes 150 through mechanical means. The term “predetermined path”, as used herein, means a unidirectional path extending through the liquid, as opposed to vibrations. As will be described below, in one embodiment the predetermined path extends through different portions of the liquid, where the direction of the path can be different in each portion of the liquid. Additionally, as will be described below, in one embodiment the predetermined path is a rotational path.

Particularly, pump 155 pumps liquid through first section 161 of pipe 160 into first end 111 of vessel 110 and pulls liquid from second end 112 of vessel 110 through second section 162 of pipe 160, thereby creating an upward flow of liquid within vessel 110. The diameter of middle section 116 of vessel 110 and the flow rate of pump 155 are selected such that the average upward liquid velocity therein is equal to the free falling velocity of third electrodes 150, therefore third electrodes 150 are suspended in the liquid of vessel 110. It is noted that in an embodiment where third electrodes 150 are elongated, the free falling velocity thereof is a function of the alignment angle of third electrodes 150.

In the embodiment where the diameter of second section 115 increases towards second base 118 thereof, the upward liquid velocity therein decreases, thereby causing third electrodes 150 which reach second section 115 of vessel 110 to fall downwards towards middle section 116. Similarly, in the embodiment described above where the diameter of first section 114 decreases towards second base 118 thereof, the upward liquid velocity therein increases, thereby causing third electrodes 150 which reach first section 114 to be pushed back into middle section 116.

Electric pulse generator 135 provides pulses at a predetermined voltage across first electrode 113 and second electrode 120. In one non-limiting embodiment, the frequency of electric pulse generator 135 is about 1 kHz. The combination of gravity and the mechanical force of the liquid flow provided by pump 155 causes third electrodes 150 to chaotically and alternately form, and interrupt, a conducting pathway between first electrode 113 and second electrode 120. Particularly, at certain undetermined times, a continuous path 170 is formed between first electrode 113 and second electrode 120 via a set of third electrodes 150, thereby allowing current to flow therethrough from electric pulse generator 135. Continuous path 170 can be formed by third electrodes 150 in contact with each other and first and second electrodes 113 and 120, or by third electrodes 150 which are not in contact but are within a short enough distance, i.e. within a few microns. Continuous path 170 is broken by the turbulent flow within vessel 110, which causes the current flowing therethrough to form an arc discharge. As described above, the arc discharge creates a plasma bubble.

Providing a pulsed current creates pulsed arc discharges. This is more efficient than providing a continuous current which will create a continuous discharge. In one embodiment (not shown), a rotating magnetic field is further provided, as described above in relation to liquid treatment apparatus 10. In such an embodiment, the rotating magnetic field aids in the suspension of third electrodes 150 and causes additional movement of third electrodes 150, thereby increasing the frequency of pulsed arc discharges.

Optional valves 140 facilitate filling and discharging vessel 110 when vessel 110 is used in a batch process. Alternatively, when liquid treatment apparatus 100 is used in an in-line mode, first optional valve 140 inserts into vessel 110 liquid to be treated and second optional valve 140 removes treated liquid from vessel 110.

Liquid treatment apparatus 100 has been described in an embodiment where walls 113 of vessel 110 constitute the first electrode, however this is not meant to be limiting in any way. In another embodiment, an electrode is disposed on walls 113 and is not an integral part of walls 113. Additionally, liquid treatment apparatus 100 has been described in an embodiment where a single first electrode 113 and a single second electrode 120, in the center of vessel 110 has been described, however this is not meant to be limiting in any way. In another embodiment, a plurality of first electrodes 113 and/or a plurality of second electrodes 120 are provided, without exceeding the scope.

In one embodiment, at least one of first electrode 113, second electrode 120 and third electrodes 150 comprise iron. Effectiveness is thus improved due to the production of Fe ions which can participate in Fenton's reaction. In another embodiment, at least one of first electrode 113, second electrode 120 and third electrodes 150 comprise titanium. Effectiveness is thus improved due to the formation of titanium peroxides on the surface of particles generated by the arc. In another embodiment, at least one of first electrode 113, second electrode 120 and third electrodes 150 comprise copper, which similarly increases efficiency.

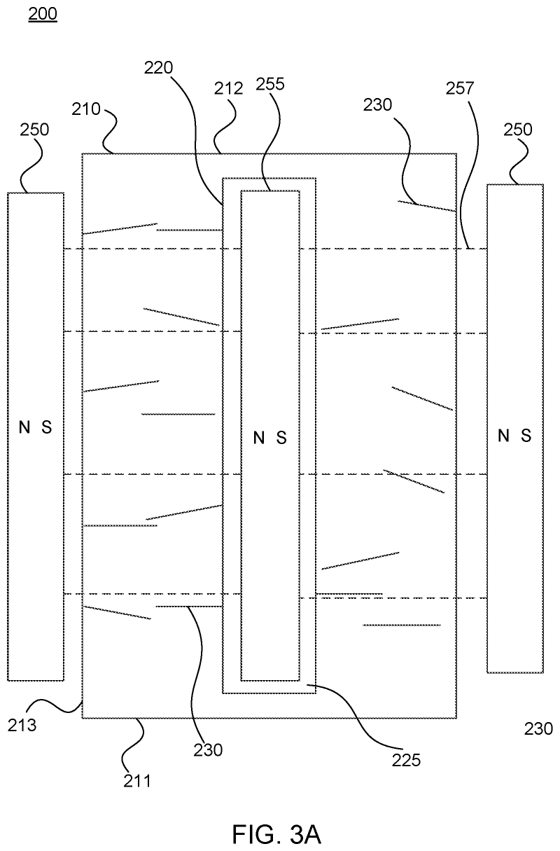

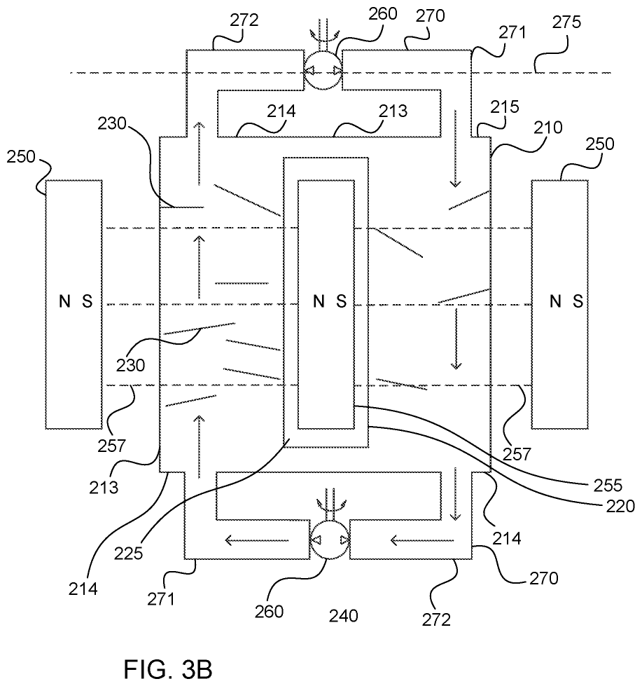

FIG. 3A illustrates a high level schematic cross-sectional diagram viewed from the side of a liquid treatment apparatus 200 and FIG. 3B illustrates a high level schematic cross-sectional diagram viewed from the top of liquid treatment apparatus 200, FIGS. 3A-3B being described together. Liquid treatment apparatus 200 comprises: a vessel 210 extending from a first end 211 to a second end 212 and arranged to contain liquid, walls 213 of vessel 110 arranged to form a first electrode; a second electrode 220; a plurality of third electrodes 230 disposed within the liquid in vessel 210; a mechanical force generator 240; a pair of outer magnets 250; and an inner magnet 255. An electric pulse generator is further provided, as described above in relation to liquid treatment apparatus 100, and is not shown for simplicity. Each wall 213 of vessel 210 exhibits a first half 214 and a second half 215. Outer magnets 250 and inner magnet 255 are fixed magnets, i.e. they generate a fixed magnetic field. This is in contrast to the rotating magnetic field generated in liquid treatment apparatus 10.

Each third electrode 230 is composed of magnetic material, the magnetic material being diamagnetic, paramagnetic, ferromagnetic or antiferromagnetic. In one embodiment, each third electrode 230 is composed of a paramegnetic or an antiferromagnetic material. In another embodiment, each third electrode 230 is composed of a ferromagnetic material. In one embodiment, as described above, each of first electrode 213, second electrode 220 and third electrode 230 are composed one or more of: iron; titanium; and copper. In one embodiment, each third electrode 230 exhibits an elongated shape. In one further embodiment, the length to diameter ratio is between 2-5. In another further embodiment, the length to diameter ratio is greater than 5.

Mechanical force generator 240 comprises: a pair of pumps 260; and a pair of pipes 270, each exhibiting a first section 271 and a second section 272. In one embodiment, second electrode 220 extends from first end 211 to second end 212 of vessel 210, in the center of vessel 210. In one embodiment, each of outer magnets 250 and inner magnet 255 is generally rectangular cuboid shaped.

Outer magnets 250 are generally parallel to each other, and vessel 210 is positioned between outer magnets 250. Inner magnet 255 is positioned within vessel 210. In the embodiment where second electrode 220 is in the center of vessel 210, inner magnet 255 is situated within second electrode 220, i.e. second electrode is shaped such that it surrounds a space 225, and inner magnet 255 is disposed within space 225. Outer magnets 250 and inner magnet 255 are positioned such that a magnetic field is generated between each outer magnet 250 and inner magnet 255. Respective magnetic field lines 257 are illustrated as dashed lines between the south pole of a first outer magnet 250 and the north pole of inner magnet 255 and respective magnetic field lines 257 are illustrated as dashed lines between the north pole of the second outer magnet 250 and the south pole of inner magnet 255.

First section 271 of a first pipe 270 enters vessel 210 through a first wall 213, at first half 214 thereof and second section 272 of the first pipe 270 exits vessel 210 through the first wall 213 at second half 215 thereof. First section 271 of the second pipe 270 enters vessel 210 through a second wall 213, at second half 215 thereof, second wall 213 opposing first wall 213. Second section 272 of the second pipe 270 exits vessel 210 through the second wall 213 at first half 214 thereof. In one illustrated embodiment, each pump 260 is positioned between first section 271 and second section 272 of a respective pipe 270, however this is not meant to be limiting in any way. In another embodiment, each pump 260 is disposed within the respective pipe 270. In one preferred embodiment, first and second pipes 270 are disposed within a plane 275.

In operation, third electrodes 230 are suspended within the liquid by the magnetic fields of outer magnets 250 and inner magnet 255. In the embodiment where third electrodes 230 exhibit an elongated shape, third electrodes 230 tend to align parallel to magnetic field lines 257 within the liquid. Alignment of third electrodes 230 with magnetic field lines 257, as well as the tendency of the magnetic field to be intensified at the ends of third electrodes 230, increases the probability that a conducting path will be created by a set of third electrodes 230 between first electrode 213 and second electrode 220. As described above, a current is supplied from the electric pulse generator through the conducting path. Preferably, the current is pulsed.

Mechanical force generator 240 provides a predetermined mechanical force along a predetermined path within the liquid and a portion of the predetermined mechanical force is applied to third electrodes 230. Particularly, each pump 260 pumps liquid through first section 271 of the respective pipe 270 into vessel 210 and pulls liquid from vessel 110 through second section 272 of the respective pipe 270, thereby creating a flow of liquid within vessel 210 in a direction which is generally perpendicular to magnetic field lines 257. Such a direction of flow increases the frequency of interruption of the conducting paths, and the creation of the respective arc discharges, as described above. Thus, the flow causes third electrodes 230 to chaotically and alternately form, and interrupt, a conducting pathway, while the magnetic fields increase the frequency of formation of conducting pathways.

Advantageously, outer magnets 250 and inner magnet 255, which do not require any energy, are used to suspend and orient third electrodes 230, in contrast to a rotating magnetic field. Additionally, the flow required by pumps 260 is much weaker than that provided by pump 155 of liquid treatment apparatus 100, because the flow is only used to disrupt the conducting pathways, and not to suspend third electrodes 230 against the force of gravity.

In one embodiment (not shown), as described above, valves and ports are provided for filling and emptying vessel 210 in batch operations, or for allowing liquid to flow through vessel 210 in in-line operations. Additionally, in one embodiment pipes 270 are protected by respective screens which allow passage of liquid therethrough, while preventing passage of third electrodes 230 therethrough.

Liquid treatment apparatus 200 is described in an embodiment where pumps 260 pump liquid along a plane 275, however this is not meant to be limiting in any way. In another embodiment, additional pumps are provided which pump liquid along additional planes, preferably parallel to plane 275. Alternatively, a single pump is provided, which is connected to a manifold with pipes connected at various heights along vessel 210.

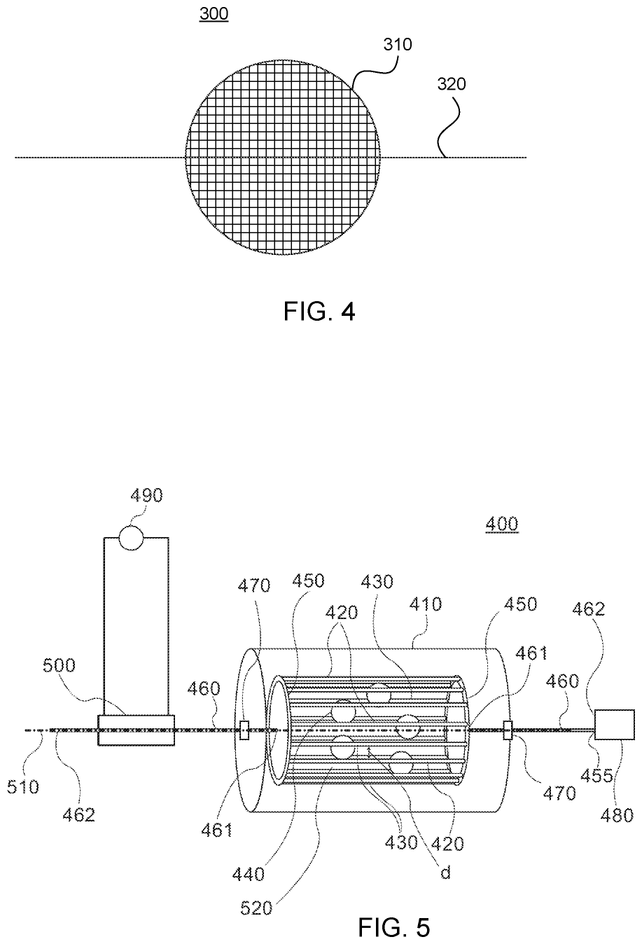

FIG. 4 illustrates a high level schematic cross-sectional diagram of a buoyant electrode assembly 300, in accordance with certain embodiments. Buoyant electrode assembly 300 comprises: buoyant material 310, such as Styrofoam; and at least one electrode 320. In one embodiment, electrode 320 is implemented as one of third electrodes 150 or 230. Although only a single electrode 320 is illustrated within buoyant electrode assembly 300, this is not meant to be limiting in any way. In another embodiment, a plurality of electrodes 320 are provided, each extending through buoyant material 310 at a different angle. In one further embodiment, 2 electrodes 320 are provided, each generally orthogonal to each other. In another further embodiment, 3 electrodes 320 are provided, each generally orthogonal to each other. In one preferred embodiment, the materials and relative masses of buoyant material 310 and the at least one electrode 320 are chosen so that they will be generally neutrally buoyant in liquid. Using buoyant electrode assemblies 300 is preferable because no force is required for their suspension in the liquid. Relatively weak magnets can be used to align electrodes 320, as described above in relation to liquid treatment apparatus 200, as the magnetic fields are not necessary to keep electrodes 320 buoyant. Additionally, electrodes 320 can be made thicker because it is held buoyant by buoyant material 310. Advantageously, this will increase the lifetime of electrodes 320 in the face of arc erosion.

In the embodiments described below, arc discharges are initiated by momentary contact of conducting members with electrode pairs, when there is sufficient relative velocity between the conducting members and the electrode pairs such that the conducting members rebound from the electrode pairs so that the contact is momentary.

FIG. 5 illustrates a high level schematic diagram of a liquid treatment apparatus 400. Liquid treatment apparatus 400 comprises: a vessel 410 arranged to contain liquid; a plurality of first electrodes 420; a plurality of second electrodes 430; a plurality of third electrodes 440; a pair of flanges 450; a mechanical force generator 455 comprising a pair of drive shafts 460, a pair of feedthroughs 470 and a motor 480; an electric pulse generator 490; and an electrode connector 500. Each drive shaft 460 exhibits a first end 461 and a second end 462, second end 462 opposing first end 461. In one preferred embodiment, each of first electrodes 420 and second electrodes 430 exhibits an elongated shape. In another embodiment, each third electrode 440 is generally spherical shaped, however this is not meant to be limiting in any way. A plurality of third electrodes 440 are illustrated and described herein, however this is not meant to be limiting in any way. In another embodiment, only a single third electrode 440 is provided, without exceeding the scope.

Each of the plurality of first electrodes 420 and second electrodes 430 extend from a first flange 450 to the second flange 450, and are arrayed about a central axis 510, thereby forming a rotation assembly 520. Flanges 450 are insulated from first electrodes 420 and second electrodes 430. In one embodiment, flanges 450 are each constructed of electrically insulating material. In another embodiment (not shown), insulation devices are provided to electrically insulate flanges 450 from first electrodes 420 and second electrodes 430.

First electrodes 420 and second electrodes 430 are adjacent to each other. Particularly, each first electrode 420 is adjacent to a respective second electrode 430. In one embodiment, each first electrode 420 is adjacent to two second electrodes 430 situated on either side thereof, and each second electrode 430 is adjacent to two first electrodes 420 situated on either side thereof. Each drive shaft 460 enters vessel 410 via a respective feedthrough 470, such that first end 461 thereof is situated within vessel 410 and second end 462 thereof is situated outside of vessel 410. First end 461 of each drive shaft 460 is coupled to a respective flange 450 and second end 462 of one of the pair of drive shafts 460 is coupled to motor 480. Each first electrode 420 is in electrical communication with a first polarity output of electric pulse generator 490, via electrode connector 500 (connections not shown for simplicity). Each second electrode 430 is in electrical communication with a second polarity output of electric pulse generator 490, via electrode connector 500 (connections not shown for simplicity), the second polarity opposing the first polarity. In one embodiment, motor 480 is operated by a dedicated power source (not shown). In another embodiment, motor 480 is operated by electric pulse generator 490.

Third electrodes 440 are in one illustrated embodiment situated within rotation assembly 520, however this is not meant to be limiting in any way. In another embodiment, third electrodes 440 are situated between rotation assembly 520 and the walls of vessel 410. In one embodiment, at least one dimension of each third electrode 440 is greater than the distance between two adjacent ones of first electrodes 420 and second electrodes 430, denoted d, such that third electrodes 440 cannot leave, or enter, rotation assembly 520. In another embodiment, third electrodes are each spherical shaped, exhibiting a diameter between 1-50 mm. In one embodiment, third electrodes 440 are buoyant, such as those described in relation to buoyant electrode assembly 300.

In operation, mechanical force generator 455 provides a predetermined mechanical force along a predetermined path within the liquid. Particularly, motor 480 rotates the respective drive shaft 460 so as to rotate first electrodes 420 and second electrodes 430 about central axis 510 at a predetermined speed. The predetermined path of the mechanical force is the rotational path of first electrodes 420 and second electrodes 430. A portion of the predetermined mechanical force of the rotation is applied to third electrodes 440, when third electrodes come in contact with one of first electrodes 420 and second electrodes 430, which cause them to bounce back and forth, or to be carried upward and released to fall downward.

In an embodiment where third electrodes 440 are situated within rotation assembly 520, third electrodes 440 achieve momentum responsive to the rotation of rotation assembly 520. Each time a third electrode 440 hits one or more of first electrodes 420 and second electrodes 430, the third electrode 440 returns back with additional momentum from the rotation of rotation assembly 520. In an embodiment where third electrodes 440 are situated between rotation assembly 520 and the walls of vessel 410, third electrodes 440 achieve momentum when hitting rotation assembly 520, responsive to the rotation thereof. Third electrodes 440 then bounce off the walls of vessel 410 towards rotation assembly 520 and achieve additional momentum when contacting rotation assembly 520 responsive to the rotation thereof.

As described above, electric pulse generator 490 outputs a pulsed electric voltage. When a third electrode 440 hits, simultaneously, a first electrode 420 and an adjacent second electrode 430, a current path is formed, as described above. The current path exists only momentarily, because third electrode 440 bounces away from the pair of electrodes, thereby forming a pulsed arc discharge.

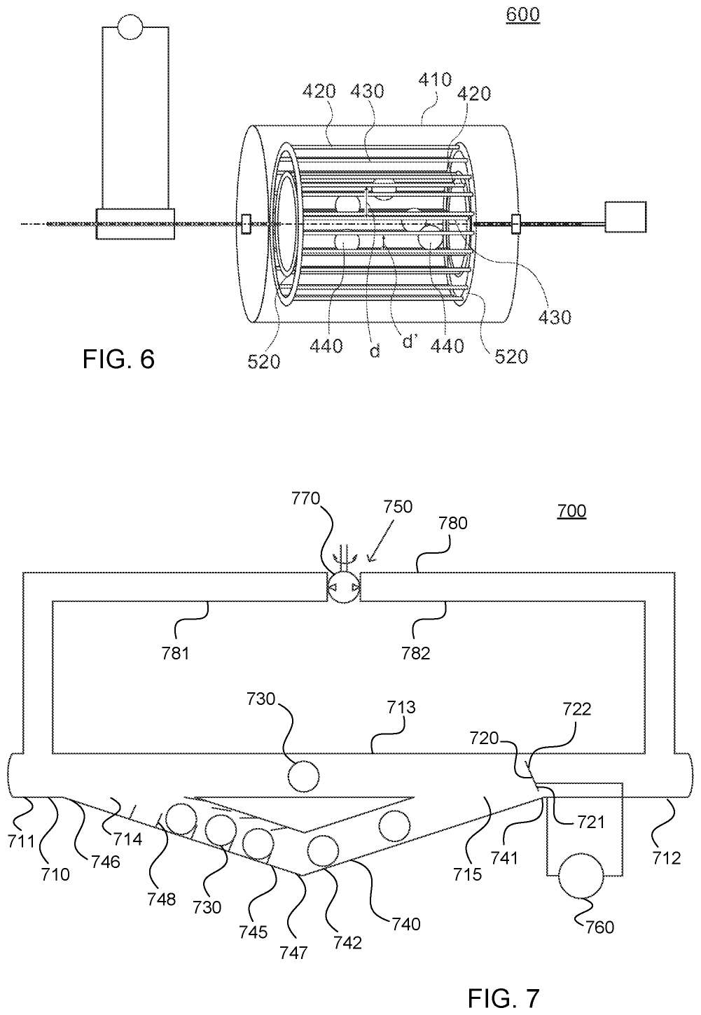

FIG. 6 illustrates a high level schematic diagram of a liquid treatment apparatus 600. Liquid treatment apparatus 600 is in all respects similar to liquid treatment apparatus 400, with the exception that a plurality of concentric rotation assemblies 520 are provided, i.e. each rotation assembly 520 is situated within another rotation assembly 520. In one embodiment, third electrodes 440 are situated between adjacent rotation assemblies 520 and within the innermost rotation assembly 520. Third electrodes 440 which are situated between adjacent rotation assemblies 520 create arc discharges responsive to hitting first and second electrodes 420 and 430 of each of the respective rotation assemblies 520. Advantageously, a higher rate of collisions between third electrodes 440 and adjacent first and second electrodes 420 and 430 is achieved. Therefore, a higher submerged arc pulse rate and decontamination rate is achieved. Additionally, the submerged arcs are distributed more uniformly throughout the volume of vessel 410.

In one embodiment, distance d of each rotation assembly 520 is different. Particularly, distance d of the innermost rotation assembly 520 is the largest. Distance d decreases for each adjacent rotation assembly 520, such that distance d is smallest in the outermost rotation assembly 520. Third electrodes 440 tend to undergo arc erosion, and thus their size decreases over a period of operation. New replacement third electrodes 440 are inserted into the innermost rotation assembly from time to time. At least one initial dimension of the new third electrodes 440 is greater than distance d of the innermost rotation assembly 520. As arc erosion decreases the size of third electrodes 440, they will pass between the first and second electrodes 420 and 430 of the innermost rotation assembly 520, but become trapped between the innermost rotation assembly 520 and the adjacent rotation assembly 520, which has a smaller distance d. With increased operation time, the size of at least some of the trapped third electrodes 440 decreases further and escape from the second rotation assembly 520, but are trapped by the next adjacent rotation assembly 520, which has an even smaller distance d. This process continues until third electrodes 440 escape the outermost rotation assembly 520, which has the smallest distance d, at which time those third electrodes 440 will be removed from vessel 410.

FIG. 7 illustrates a high level schematic diagram of a liquid treatment apparatus 700. Liquid treatment apparatus 700 comprises: a vessel 710 arranged to contain a liquid, vessel 710 extending from a first end 711 to a second end 712; a second electrode 720 extending from a first end 721 to a second end 722; a plurality of third electrodes 730; a collection mechanism 740 extending from a first end 741 to a second end 742; an ejection mechanism 745 extending from a first end 746 to a second end 747; a mechanical force generator 750; and an electric pulse generator 760.

In one embodiment, vessel 710 is generally cylindrical shaped such that a cross-section diameter is greater than a diameter of each third electrode 730, preferably 105-195% of the diameter of each third electrode 730. In one embodiment, walls 713 of vessel 710 form a first electrode. In another embodiment (not shown), walls 713 are covered with one or more electrodes. Second electrode 720 is shaped as a grate which allows liquid to flow therethrough, while not allowing third electrodes 730 to pass therethrough. In one embodiment, each third electrode 730 is generally spherical shaped. Mechanical force generator 750 comprises: a pump 770; and a pipe 780 exhibiting a first section 781 and a second section 781. In one embodiment, each of collection mechanism 740 and ejection mechanism 745 is generally cylindrical shaped. In one illustrated embodiment, ejection mechanism 745 comprises a plurality of movable flaps 748.

First electrode 713 is in electrical communication with a first output polarity of electric pulse generator 760 and second electrode 720 is in electrical communication with a second output polarity of electric pulse generator 760, the second polarity opposing the first polarity. Second electrode 720 extends between walls 713 of vessel 710, such that first end 721 and second end 722 are close to, but are not in contact with, first electrode 713. Particularly, the distance between first end 721 and first electrode 713 and the distance between second end 722 and first electrode 713 is large enough such that an electric charge cannot pass from first electrode 713 to second electrode 720, and is small enough such that a third electrode 730 can complete a connection between first electrode 713 and second electrode 720.

First end 746 of ejection mechanism 745 enters vessel 710 at a first port 714 and first end 741 of collection mechanism 740 exits vessel 710 at a second port 715. Second electrode 720 is positioned between second port 715 and second end 712 of vessel 710. First port 714 is positioned between first end 711 and second port 715 of vessel 710. Second end 742 of collection mechanism 740 is coupled to second end 747 of ejection mechanism 745 such that liquid and third electrodes 730 can pass from collection mechanism 740 to ejection mechanism 745. In one embodiment, collection mechanism 740 extends from vessel 710 at a respective angle and ejection mechanism 745 extends from vessel 710 at a respective angle, such that vessel 710, collection mechanism 740 and ejection mechanism 745 form a generally trianglular shape.

First section 781 of pipe 780 enters vessel 710 at first end 711 thereof and second section 782 of pipe 780 exits vessel 710 at second end 712 thereof. In one illustrated embodiment, pump 770 is situated between first section 781 and second section 782 of pipe 780, however this is not meant to be limiting in any way. In another embodiment, pump 770 is situated within pipe 780.

In operation, electric pulse generator 760 provides electric pulses of a predetermined voltage to first electrode 713 and second electrode 720, as described above. Mechanical force generator 750 provides a predetermined mechanical force along a predetermined path within the liquid. Particularly, pump 770 circulates the liquid in vessel 710 at a high velocity, from first end 711 to second end 712, as illustrated by the arrows. A portion of the predetermined mechanical force is applied to third electrodes 730 so as to chaotically and alternately form, and interrupt, a conducting pathway between first electrode 713 and second electrode 720. Particularly, third electrodes 730 which are in vessel 710 are propelled towards second electrode 720. When a third electrode 730 comes in contact with second electrode 720, due to a chaotic motion provided by the liquid flow, there is a chance that the third electrode 730 will simultaneously come in contact with first electrode 713. As a result, current will flow through the path formed by first electrode 713, second electrode 720 and the third electrode 730 in contact therewith. Responsive to hitting second electrode 720, the third electrode 730 bounces back, thereby the current path is quickly disrupted, forming a pulsed arc discharge, as described above.

Third electrodes 730 enter collection mechanism 740 through second port 715 after hitting second electrode 720, aided by gravity and the angle at which second electrode 720 is mounted, and continue into ejection mechanism 745. In the embodiment where movable flaps 478 are provided in ejection mechanism 745, movable flaps 478 move third electrodes 730 towards first port 714 of vessel 710. Additionally, or alternatively, the high velocity flow through vessel 710 pulls third electrodes 730 out of ejection mechanism 745 through first port 714.

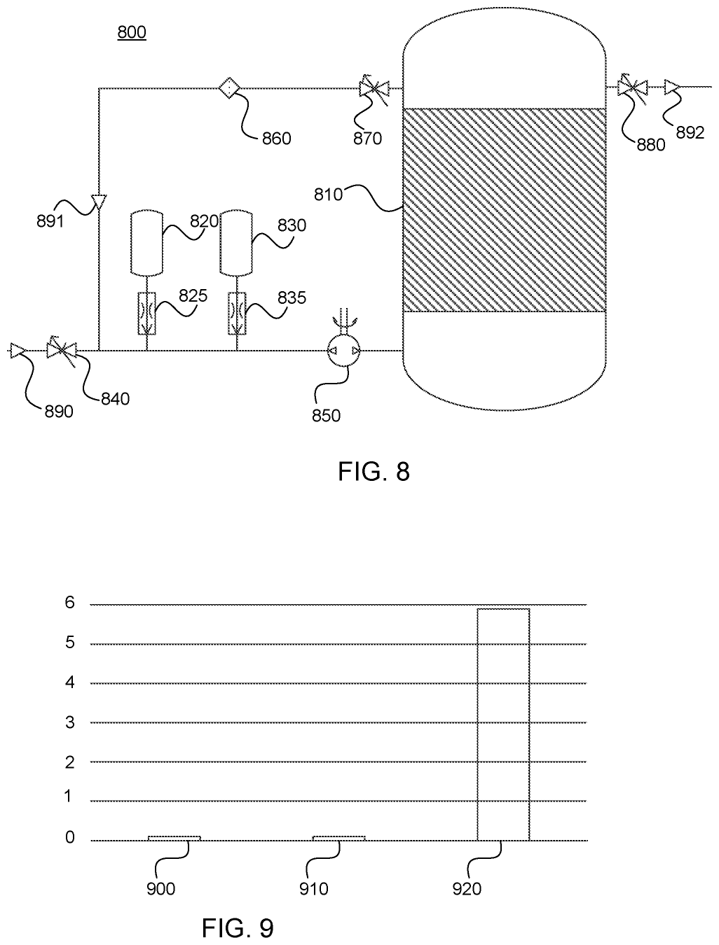

FIG. 8 illustrates a high level schematic diagram of a chemical substance addition system 800, used in conjunction with a vessel 810. Vessel 810 can be any of vessels 20, 110, 210, 310, 410 and 710, described above. Chemical substance addition system 800 comprises: a vessel 820; a valve 825; a vessel 830; a valve 835; a valve 840; a pump 850; an optional filter 860; a valve 870; and a valve 880. Liquid flow directions are further illustrated by arrows 890, 891 and 892.

An output of valve 840 is coupled to an output of valve 825, an output of valve 835, an input of pump 850 and an output of optional filter 860. An input of valve 825 is coupled to an output of vessel 820 and an input of valve 835 is coupled to an output of vessel 830. An output of pump 850 enters vessel 810 at respective port thereof (not shown). An input of optional filter 860 is coupled to an output of valve 870 and an input of valve 870 exits vessel 810 at a respective port thereof (not shown). An input of valve 880 exits vessel 810 at a respective port thereof (not shown).

In operation, liquid requiring treatment, such as waste water, enters the system through valve 840, as indicated by arrow 890. In a batch process, valve 840 is open for a predetermined amount of time to allow vessel 810 to be filled, the filling of vessel 810 aided by pump 850. In an in-line continuous process, valve 840 remains open continuously. Chemical substances are stored in vessels 820 and 830. In one embodiment, vessel 820 contains hydrogen peroxide (H₂O₂) and vessel 830 contains hydrochloric acid (HCl). Valves 825 and 835 regulate the flow of the substances of the respective vessels 820 and 830 into vessel 810. In a batch process, valves 825 and 835 are opened when filling vessel 810. Alternatively, the flow of the substances out of vessels 820 and 830 is continuous, at a controlled rate, to replace the substances as they are depleted in the process. In an in-line continuous process, valves 825 and 835 provide a continuous stream of the substances of vessels 820 and 830 into the liquid to be treated. In some batch processes, it is desirable to filter out solid particles generated by the arc discharge. Thus, valve 870 periodically, or continuously, streams liquid out of vessel 810 into optional filter 860. The filtered liquid is returned to vessel 810 via pump 850, as indicated by arrow 891. The treated liquid is removed from vessel 810 via valve 880, as indicated by arrow 892.

### EXAMPLES

### Example 1

The effects of adding chemicals to the process are shown in the experiments summarized in Table 1. 10 mg/L Methylene Blue (MB) solutions were treated with submerged arcs using the rotating magnetic field of liquid treatment apparatus 10. The rotating magnetic field was produced by coils of a 3-phase electrical motor to rotate third electrodes 70 comprising iron nails and to produce momentary contacts between them and first and second electrodes 25 and 30. SA discharges were produced by a pulse generator 80 which included a 15 μF capacitor charged to 30 V. The parameters of the pulses and their frequency were of a random nature, determined by the formation of momentary contacts between the third electrodes 70 and the first and second electrodes 25 and 30. The treated volume was 600 ml. Third electrodes 70 with a ratio of the length to diameter 1/d=7-21 were used. Volume concentration of third electrodes 70 (Cv) in the range of 1.2%-9% was tested. Addition of H₂O₂ and HCl was also examined. The liquid, after 2 min of SA treatment, was filtered through a Whatman 595 ½ filter. Then, the filtered solution was again arc treated. This cycle of 2 minutes of arc treatment followed by filtration was repeated in some cases. At the end of this treatment, the liquid was 95% decontaminated. All these samples (1-6) are presented in Table 1.

TABLE 1

| | | | | | | | Results | |
|---|---|---|---|---|---|---|---|---|
| | | Parameters and conditions of SA treatment | | | | | Required | Yield |
| | | | | | | Arc | energy | of |
| | | | | | | treatment | per unit | 95% |
| | Pulse | | | | Chemical | time, | volume, | decontamined |
| | parameter | 1/d | Cᵥ, % | Filtration | addition | min | kW hr/m³ | g/kW hr |
| 1 | 15 μF | 12 | 4 | 2 min arcing | No | 8 | 0.88 | 11.4 |
| | 30 V | | | and filtration | | | | |
| | | | | were repeated | | | | |
| | | | | 4 times | | | | |
| 2 | 15 μF | 7 | 4 | 2 min arcing | No | 44 | 5 | 2 |
| | 30 V | | | and filtration | | | | |
| | | | | were repeated | | | | |
| | | | | 22 times | | | | |
| 3 | 15 μF | 21 | 4 | 2 min arcing | No | 72 | 8 | 1.25 |
| | 30 V | | | and filtration | | | | |
| | | | | were repeated | | | | |
| | | | | 36 times | | | | |
| 4 | 15 μF | 12 | 1.2 | 2 min arcing | No | 32 | 3.6 | 2.8 |
| | 30 V | | | and filtration | | | | |
| | | | | were repeated | | | | |
| | | | | 16 times | | | | |
| 5 | 15 μF | 12 | 9 | Process was disrupted because due to short circuits | | | | |
| | 30 V | | | | | | | |
| 6 | 15 μF | 12 | 4 | Filtration after 2 | 0.01% | 2 | 0.22 | 45 |
| | 30 V | | | min | of H₂O₂ | | kW hr/m³ | |
| | | | | | and | | | |
| | | | | | 0.002% | | | |
| | | | | | of HCl | | | |
| 7 | 25 μs | 12 | 4 | Filtration after | 0.01% | 0.5 | 0.18 | 540 |
| | 10 V | | | 0.5 min | of H₂O₂ | | | |
| | | | | | and | | | |
| | | | | | 0.002% | | | |
| | | | | | of HCl | | | |

As shown in Table 1, adding H₂O₂ and HCl to the process significantly reduces the amount of time and energy necessary for treatment of the liquid. In process 7 in Table 1, 1800 ml of 100 mg/l MB solution was treated. A different pulse generator was used, i.e. a voltage amplitude of 10 V and a pulse duration of 25 μs. As shown in Table 1, decontamination of the liquid was achieved after only 0.5 minutes. Additionally, a 95% decontamination yield of 540 g/kW-hr was reached, which is an order of magnitude greater than with the pulses of process 6.

### Example 2

Liquid treatment apparatus 10 was utilized to treat wastewater from a pharmaceutical plant, containing amines and salts, particularly NaCl with a concentration ˜1,000 mg/l, and with an initial total organic carbon (TOC) concentration of ˜5,000 mg/l. With a treatment time of 2 minutes, the energy expenditure per unit volume was 0.8 kW hr/m³ and the TOC was reduced by 5%. With a treatment time of 8 minutes, the energy expenditure per unit volume was 3.2 kW hr/m³ and the TOC was reduced by 8%.

This process was then repeated in conjunction with chemical substance addition system 800. Particularly, 0.05% of H₂O₂ and 1% of HCl were added to the wastewater. With a treatment time of 2 minutes, the energy expenditure was 0.8 kW hr/m³, and 95% of the TOC was removed. A comparison of the results are shown in FIG. 9, where bars 900, 910 and 920 show the TOC conversion yield for each experiment. Particularly, bar 900 shows the TOC conversion yield for the treatment time of 2 minutes with no addition of H₂O₂ and HCl to the process and bar 910 shows the TOC conversion yield for the treatment time of 8 minutes with no addition of H₂O₂ and HCl to the process. Bar 920 shows the TOC conversion yield for the treatment time of 2 minutes with the addition of H₂O₂ and HCl to the process. As shown, the addition of H₂O₂ and HCl is significantly beneficial.

### Example 3

Liquid treatment apparatus 10 was utilized to treat wastewater from a pharmaceutical plant, containing amines and salts, particularly NaCl with a concentration ˜1,000 mg/l, and with an initial total organic carbon (TOC) concentration of ˜20,000 mg/l, i.e. similar to example 2 except for a higher TOC. With 2 minutes of arc treatment, the energy expenditure was ˜0.8 kW hr/m³, and the TOC was reduced by 3%.

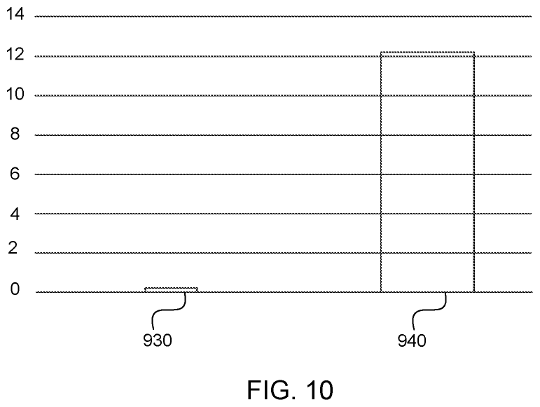

The above process was repeated in conjunction with chemical substance addition system 800. Particularly, 0.1% of H₂O₂ and 2% of HCl were added to the wastewater. With 2 minutes of arc treatment, the energy expenditure was ˜0.8 kW hr/m³ and the TOC was reduced by 50%. A comparison of the results is shown in FIG. 10, where bars 930 and 940 show the TOC conversion yield for each experiment. Particularly, bar 930 shows the TOC conversion yield for the treatment time of 2 minutes with no addition of H₂O₂ and HCl to the process and bar 940 shows the TOC conversion yield for the treatment time of 2 minutes with the addition of H₂O₂ and HCl to the process. As shown, the addition of H₂O₂ and HCl is significantly beneficial.

### Example 4

40 ml liquid samples composed of 10 mg/L Methylene Blue (MB) aqueous solutions were SA treated using two iron electrodes, one of which was stationary, and the other was movable. The movable electrode was mounted on a vibrator which induced oscillatory motion at the distal end of the movable electrode with an amplitude of ˜0.5 mm and a frequency of 100 Hz. The vibrator and movable electrode were arranged so that the distal end of the movable electrode contacted and then broke contact with the stationary electrode once in every vibrational cycle within the MB solution. SA discharges were produced by a pulse generator which included a 15 μF capacitor charged to 80V. The positive pole of the generator was connected to the movable electrode, and the negative pole to the stationary electrode. One discharge was produced each time the movable electrode broke contact with the stationary electrode. The arc treatment time was 4 minutes. After arc treatment, the solution was filtered through a Whatman 595 ½ filter. Measurement of the spectral absorption at 664 nm one hour after SA processing showed that MB concentration was reduced to 5% of its initial concentration. The energy expended per unit volume was 7.2 kW hr/m³.

This process was repeated wherein the stationary electrode was made from copper. The treatment time was only 1 minute. Measurement of the spectral absorption at 664 nm one hour after SA processing showed that MB concentration was reduced to 5% of its initial concentration. The energy expenditure was 1.8 kW-hr/m³, a factor of 4 less than in the above example. Thus, it is shown here that using copper within the above described electrodes is advantageous.

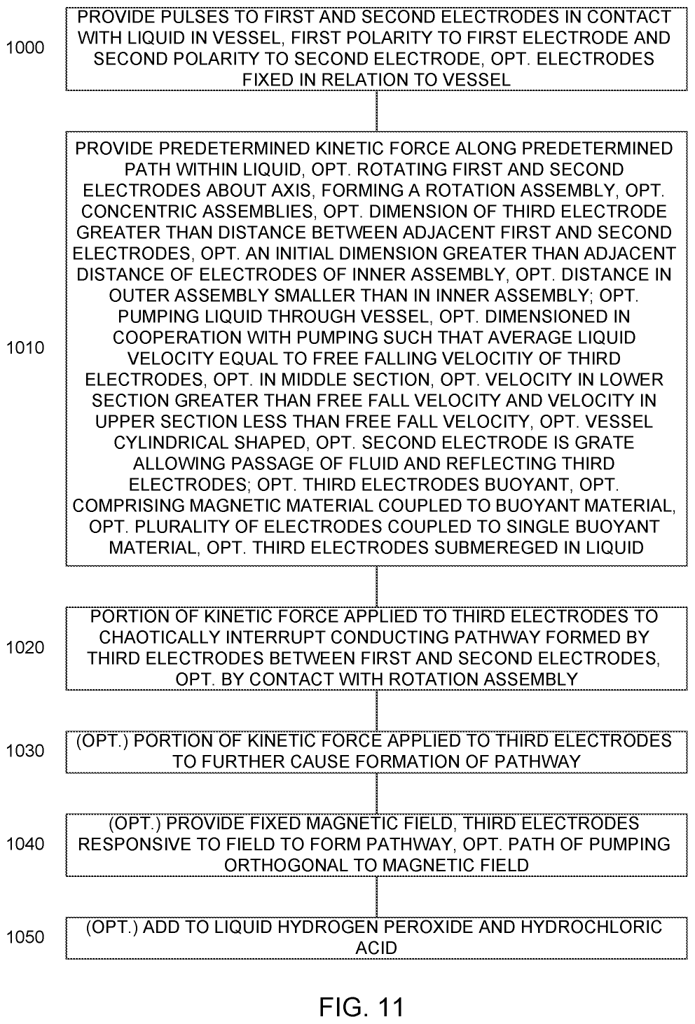

FIG. 11 illustrates a high level flow chart of a liquid treatment method, in accordance with certain embodiments. In stage 1000, electric pulses are provided to at least one first electrode in contact with a liquid inside a vessel and to at least one second electrode in contact with the liquid. A first polarity of the provided electric pulses is provided to the at least one first electrode and a second polarity of the provided electric pulses is provided to the at least one second electrode, the first polarity opposing the second polarity. In one embodiment, the first and second electrodes are fixed in relation to the vessel.

In stage 1010, a predetermined mechanical force is provided along a predetermined path within the liquid. In one embodiment, the predetermined mechanical force is provided by rotating the first and second electrodes of stage 1000 about a central axis, the first and second electrodes forming a rotation assembly, wherein each of the first electrodes is adjacent to a respective one of the second electrodes. In one embodiment, the rotation assembly surrounds the at least one third electrode. Optionally, each third electrode has at least one dimension greater than a distance between the adjacent first and second electrodes.

In another embodiment, the predetermined mechanical force is provided by rotating the first and second electrodes about a central axis, the first and second electrodes forming a plurality of concentric rotation assemblies, wherein each of the first electrodes is adjacent to a respective one of the second electrodes of the respective rotation assembly. Optionally, the third electrode has at least one initial dimension greater than a distance between the adjacent first and second electrodes of an inner one of the plurality of concentric rotation assemblies. Further optionally, a distance between the adjacent first and second electrodes of an outer one of the plurality of concentric rotation assemblies is less than a distance between the adjacent first and second electrodes of an inner one of the plurality of concentric rotation assemblies.

In another embodiment, the predetermined mechanical force is provided by pumping the liquid through the vessel of stage 1000. In one further embodiment, the vessel is dimensioned in cooperation with the pumping such that an average liquid velocity over a portion of the vessel is equal to a free falling velocity of the third electrodes. In another further embodiment, the vessel is dimensioned in cooperation with the pumping, such that: an average liquid velocity in a first portion of the vessel is greater than a free falling velocity of the third electrodes; an average liquid velocity in a second portion of the vessel is equal to the free falling velocity of the third electrodes; and an average liquid velocity in a third portion of the vessel is less than the free falling velocity of the third electrodes. Optionally, the second portion of the vessel is above the first portion of said vessel and below the third portion of the vessel. In one further embodiment, the vessel is generally cylindrical shaped, the first electrode comprises an inner wall of the vessel and the second electrode comprises a grate arranged to allow passage of the fluid while reflecting the at least one third electrode.

In one embodiment, the third electrodes are buoyant, so as to remain suspended in the liquid. In one further embodiment, the third electrodes comprise a magnetic material coupled to a buoyant material. In another further embodiment, a plurality of the third electrodes are coupled to a single buoyant material. In one embodiment, the third electrodes are submerged in the liquid.

In stage 1020, a portion of the provided predetermined mechanical force of stage 1010 is applied to the least one third electrode so as to chaotically interrupt a conducting pathway formed by the at least one third electrode between a pair of the first and the second electrodes, i.e. between a first electrode and a second electrode. It is noted that the portion of the provided predetermined mechanical force is applied to the at least one third electrode naturally, without any additional active steps.

In the embodiment where the first and second electrodes are rotated about a central axis to form a rotation assembly, the portion of the provided predetermined mechanical force is provided to the at least one third electrode by contact with the rotation assembly. In the embodiment where the first and second electrodes are rotated about a central axis to form a plurality of concentric rotation assemblies, the portion of the provided predetermined mechanical force is provided to the at least one third electrode by contact with a respective one of the concentric rotation assemblies. In the embodiment where the liquid is pumped through the vessel, the portion of the provided predetermined mechanical force is applied by a portion of the flow which comes in contact with the at least one third electrode.

In optional stage 1030, the applied portion of the provided predetermined mechanical force of stage 1020 is applied to the at least one third electrode so as to further cause the formation of the conducting pathway.

In optional stage 1040, a fixed magnetic field is provided, the third electrodes of stage 1010 responsive to the provided fixed magnetic field to form the conducting pathway. Particularly, the fixed magnetic field does not rotate, as opposed to the rotating magnetic field of liquid treatment apparatus 10. In the embodiment where the predetermined mechanical force is provided by pumping the liquid through the vessel, the pumping is arranged such that the predetermined path of the provided predetermined mechanical force is orthogonal to the provided fixed magnetic field.

In optional stage 1050, a first predetermined amount of H₂O₂, i.e. hydrogen peroxide, is added to the liquid of stage 1000. A second predetermined amount of HCl, i.e. hydrochloric acid is added to the liquid of stage 1000.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description and which are not in the prior art.

1. An apparatus for treating a liquid, the apparatus comprising:
a vessel arranged to contain the liquid;
at least one first electrode in contact with the liquid in said vessel;
at least one second electrode in contact with the liquid in said vessel;
an electrical pulse generator, a first polarity output of said electrical pulse generator coupled to each of said first electrodes and a second polarity output of said electrical pulse generator coupled to each of said second electrodes, said first polarity opposing said second polarity;
at least one third electrode disposed in the liquid in said vessel, and
a mechanical force generator arranged to provide a predetermined mechanical force, a portion of said predetermined mechanical force applied to said least one third electrode so as to chaotically interrupt a conducting pathway formed by said at least one third electrode between a pair of said first and said second electrodes,
wherein said provided predetermined mechanical force is a predetermined rotational mechanical force or a force provided by a predetermined pumped flow of the liquid through said vessel.

2. The apparatus according to claim 1, wherein the portion of said predetermined mechanical force is applied to said at least one third electrode so as to further cause said formation of said conducting pathway.

3. The apparatus according to claim 1, wherein said mechanical force generator comprises a motor coupled to rotate said first and second electrodes about a central axis,
wherein said first and second electrodes form a rotation assembly, and each of said first electrodes is adjacent to a respective one of said second electrodes,
the portion of said provided predetermined rotational mechanical force provided to said at least one third electrode by contact with said rotation assembly.

4. The apparatus according to claim 3, wherein said third electrode has at least one dimension greater than a distance between said adjacent first and second electrodes.

5. The apparatus according to claim 1, wherein said mechanical force generator comprises a motor coupled to rotate said first and second electrodes about a central axis,
wherein said first and second electrodes form a plurality of concentric rotation assemblies, wherein each of said first electrodes is adjacent to a respective one of said second electrodes of said respective rotation assembly,
the portion of said provided predetermined rotational mechanical force provided to said at least one third electrode by contact with a respective one of said concentric rotation assemblies.

6. The apparatus according to claim 5, wherein said third electrode has at least one initial dimension greater than a distance between said adjacent first and second electrodes of an inner one of said plurality of concentric rotation assemblies.

7. (canceled)

8. The apparatus according to claim 1, wherein:
said mechanical force generator comprises a pump in communication with the liquid so as to provide said predetermined pumped flow;
said first and second electrodes are fixed in relation to said vessel; and
said third electrodes are submerged in the liquid.

9. (canceled)

10. The apparatus according to claim 8, wherein said vessel is dimensioned in cooperation with said pump such that:
an average liquid velocity in a first portion of said vessel is greater than a free falling velocity of said third electrodes;
an average liquid velocity in a second portion of said vessel is equal to the free falling velocity of said third electrodes; and
an average liquid velocity in a third portion of the vessel is less than the free falling velocity of said third electrodes.

11-12. (canceled)

13. The apparatus according to claim 8, wherein said vessel is generally cylindrical shaped, said first electrode comprising an inner wall of said vessel and said second electrode comprises a grate arranged to allow passage of the fluid while reflecting said at least one third electrodes.

14. The apparatus according to claim 1, wherein said third electrodes are generally neutrally buoyant, so as to remain suspended in the liquid.

15-16. (canceled)

17. The apparatus according to claim 1, further comprising:
a first predetermined amount of H₂O₂; and
a second predetermined amount of HCl,
wherein said first predetermined amount of H₂O₂ and said second predetermined amount of HCl is added to the liquid.

18. An apparatus for treating a liquid, the apparatus comprising:
a vessel arrange to contain the liquid;
at least one first electrode in contact with the liquid in said vessel;
at least one second electrode in contact with the liquid in said vessel;
an electrical pulse generator, a first polarity output of said electrical pulse generator coupled to each of said first electrodes and a second polarity output of said electrical pulse generator coupled to each of said second electrodes, said first polarity opposing said second polarity;
at least one third electrode disposed in the liquid in said vessel, and
a mechanical force generator arranged to provide a predetermined mechanical force along a predetermined path within the liquid, a portion of said predetermined mechanical force applied to said least one third electrode so as to chaotically interrupt a conducting pathway formed by said at least one third electrode between a pair of said first and said second electrodes.

19. The apparatus according to claim 18, wherein the portion of said predetermined mechanical force is applied to said at least one third electrode so as to further cause said formation of said conducting pathway.

20. The apparatus according to claim 18, wherein said mechanical force generator comprises a motor coupled to rotate said first and second electrodes about a central axis,
wherein said first and second electrodes form a rotation assembly, and each of said first electrodes is adjacent to a respective one of said second electrodes,
the portion of said provided predetermined mechanical force provided to said at least one third electrode by contact with said rotation assembly.

21. (canceled)

22. The apparatus according to claim 18, wherein said mechanical force generator comprises a motor coupled to rotate said first and second electrodes about a central axis,
wherein said first and second electrodes form a plurality of concentric rotation assemblies, wherein each of said first electrodes is adjacent to a respective one of said second electrodes of said respective rotation assembly,
the portion of said provided predetermined mechanical force provided to said at least one third electrode by contact with a respective one of said concentric rotating assemblies.

23-24. (canceled)

25. The apparatus according to claim 18, wherein:
said mechanical force generator comprises a pump in communication with the liquid;
said first and second electrodes are fixed in relation to the vessel; and
said third electrodes are submerged in the liquid.

26-34. (canceled)

35. A liquid treatment method, the method comprising:
providing electric pulses to at least one first electrode in contact with a liquid inside a vessel and to at least one second electrode in contact with the liquid, a first polarity of said provided electric pulses provided to the at least one first electrode and a second polarity of said provided electric pulses provided to the at least one second electrode, said first polarity opposing said second polarity; and
providing a predetermined mechanical force along a predetermined path within the liquid, a portion of said predetermined mechanical force applied to said least one third electrode so as to chaotically interrupt a conducting pathway formed by the at least one third electrode between a pair of the first and the second electrodes.

36. The method according to claim 35, wherein the portion of said provided predetermined mechanical force is applied to the at least one third electrode so as to further cause said formation of said conducting pathway.

37. The method according to claim 35, wherein said providing said predetermined mechanical force along said predetermined path comprises rotating the first and second electrodes about a central axis, the first and second electrodes forming a rotation assembly,
wherein each of the first electrodes is adjacent to a respective one of the second electrodes,
wherein the portion of said provided predetermined mechanical force is provided to the at least one third electrode by contact with the rotation assembly.

38-50. (canceled)

51. The method according to claim 35, further comprising:
adding a first predetermined amount of H₂O₂ to the liquid; and
adding a second predetermined amount of HCl to the liquid.
